(19) United States
(12) Patent Application Publication
(10) Pub. No.: US 2023/0369702 A1
(43) Pub. Date: Nov. 16, 2023

(54) HOLDING DEVICE FOR ARRANGEMENT ON A BATTERY PACK OF A MACHINE TOOL

(71) Applicant: Festool GmbH, Wendlingen (DE)

(72) Inventor: Benjamin STRAUB, Kuchen (DE)

(73) Assignee: Festool GmbH, Wendlingen (DE)

(21) Appl. No.: 18/028,413

(22) PCT Filed: Sep. 7, 2021
(86) PCT No.: PCT/EP2021/074561

§ 371 Date: Mar. 24, 2023

(30) Foreign Application Priority Data
Sep. 29, 2020 (DE) 10 2020 125 435.0

(51) Int. Cl. H01M 50/247; B25F 5/02; H02J 7/00

(52) U.S. Cl. CPC H01M 50/247; B25F 5/029; H02J 7/0045; H01M 2220/30

(57) ABSTRACT

The invention relates to a holding device for arrangement on a battery pack of a machine tool, in particular a hand-held power tool, having at least one receptacle for holding a tool (14), an accessory or a consumable for the machine tool.

### CROSS-REFERENCE TO RELATED APPLICATIONS

This is a National Stage Application, filed under 35 U. S. C. 371, of International Patent Application No. PCT/EP2021/074561, filed on Sep. 7, 2021, which claims priority to German Patent Application No. 10 2020 125 435.0, filed Sep. 29, 2020, the disclosure of each of which is incorporated herein by reference in its entirety.

### BACKGROUND

The invention relates to a holding device for arrangement on a battery pack of a machine tool.

Such battery packs and machine tools are known from the prior art, for example from DE 10 2004 003 531 A1. A cordless screwdriver, which can be supplied with energy by means of a battery pack, is described therein. By means of a screwdriver bit that can be coupled to the drive shaft, the cordless screwdriver can screw and unscrew screws, for example, depending on the direction of rotation of the drive shaft. Required screwdriver bits must, for example, be carried separately in a toolbox and be coupled to the drive shaft as needed.

Another cordless screwdriver is known from DE 20 2004 000 749 U1. This cordless screwdriver has retaining grooves on the front side of the machine housing in which screw bits can be stored and removed as needed. Thus, screwdriver bits can be carried along directly on the cordless screwdriver. However, carrying screwdriver bits is limited to this cordless screwdriver. If a further machine tool which requires screwdriver bits is used, a separate carrying of screwdriver bits or a change-out of screwdriver bits from this cordless screwdriver is also required there. Thus, there is a need for optimization.

### SUMMARY OF THE INVENTION

The object of the invention is to simplify the handling of tools such as screwdriver bits with simple design means in machine tools.

The invention achieves this object by a holding device for arrangement on a battery pack of a machine tool, in particular a hand-held power tool, has at least one receptacle (one or more receptacles) for holding a tool, an accessory or a consumable or a plurality of tools, accessory parts or consumables for the machine tool.

As a result, the tools, accessory parts or consumables (hereinafter referred to occasionally as “component”) can be fastened to the battery pack by means of the holding device. One or more components can thus be inserted and held in the receptacle(s) and removed therefrom as needed (removable receptacle or removable holding). Thus, the component is available directly for the user, even when the battery pack is used on a plurality of machine tools. Regardless of the machine tool on which the user inserts the battery pack, the component arranged in the holding device is available to the user. The tool insertion and the tool change can be made easier.

The holding device can also be referred to as a tool holding device. The receptacle can extend along a longitudinal direction. The tool can be an elongated screwing or drilling tool (screw bit or drill), a saw blade (for a jigsaw), a screw, a nail and/or the like. The receptacle is preferably configured and/or determined for receiving one or more of the aforementioned components.

The machine tool can in particular be a hand-held power tool (for example, a hand-guided power tool). The machine tool can be supplied with electrical power independently of the mains by a battery pack.

The receptacle can advantageously be formed as a retaining groove or as a receiving channel. A stable receptacle is thus created with simple design means. The retaining groove serves for the removable mounting of the tool, accessory or consumable. The retaining groove is formed open on its outer side (facing away from the groove base), i.e., accessible from the outside for a component to be introduced. The receiving channel can have an elliptical circular cross section, which is open at least at one end and is closed off toward the sides by a preferably circumferential wall (similar to a bore). A tool, for example a bit, can thus be introduced into the receiving channel and removed from it again as needed.

Specifically, the groove cross section (tool holding space) of the retaining groove can be delimited by a groove base and by at least one lateral wall, in particular by two lateral walls (which flank the groove base therebetween and in some cases emanate from the groove base).

The groove cross section of the retaining groove is configured and/or determined for receiving the aforementioned components. If a component is arranged in the retaining groove, it can protrude partially from the groove cross section (component partially accommodated in the groove cross section) or be completely accommodated within the groove cross section. The retaining groove can be arranged, for example, on the casing side on the holding device or on the battery pack, in particular on an end face or a longitudinal side.

Expediently, the at least one or two lateral walls (for example relative to the groove base) can have an elastically deformable design so that, when the tool, accessory or consumable is introduced into the retaining groove, the lateral walls are elastically deformed by the tool, accessory or consumable and hold the respective component in the retaining groove. As a result, the component can be secured in a friction-locked manner in the retaining groove, because the at least one deformed (by the component) wall exerts a force on the component. Thus, the component can be clamped in the retaining groove by the at least one wall.

Optionally, engagement portions or snap hooks can be formed on the at least one lateral wall, which interact with the component arranged in the retaining groove. Alternatively or additionally, elastomer elements can be arranged on the lateral walls of the retaining groove, or the walls can be formed as elastomer elements, with which a component arranged in the retaining groove (from the outside) can be engaged from behind. This facilitates a securing of the component in the retaining groove.

Within the framework of a preferred embodiment, the holding device can at least partially cover the battery pack and/or be integrated into the battery pack. The holding device can at least partially cover the battery pack, for example, by the holding device being formed as a housing portion or part of a housing portion or a housing cover of the battery pack. The holding device can be integrated into the battery pack in such a way that it projects out of the battery pack, for example on an end face or a longitudinal side, wherein the housing portion or the housing cover of the battery pack is recessed in the region of the holding device or the receptacle.

Advantageously, the holding device can be fixedly connected to the battery pack. This creates a particularly secure assignment of the holding device to the battery pack. For example, the holding device cannot be detachably attached to the battery pack in a non-destructive manner.

Alternatively, the holding device can be mounted on the battery pack and can be reversibly removable from the battery pack, wherein the holding device at least partially surrounds the battery pack in the mounted state. Thus, the holding device can be placed on the battery pack and removed therefrom as needed. The holding device is therefore, with respect to the battery pack, a separate element, by means of which element the battery pack can be protected at least in portions when the holding device is mounted. The holding device can thus be formed as a protective cover for the battery pack. In the case of a plurality of battery packs as well, a holding device is sufficient, because the holding device can be placed on the battery pack which is currently being used.

Expediently, the holding device can have a base portion and wall portions protruding from the base portion. Thus, the holding device can be formed as a slide-on cover or a push-on “shoe”. The base portion serves to cover the battery pack on a side of the battery pack (bottom) that faces away from the coupling side of the battery pack on which a coupling device for mechanically and electrically connecting the battery pack to the machine tool is located. The battery pack can thus be protected on the side (bottom) facing away from the coupling side and on the casing sides.

In an advantageous manner, the wall portions can comprise end-face wall portions and longitudinal-side wall portions, which connect the end-face wall portions to one another. As a result, the battery pack can be protected from environmental influences on the end faces and longitudinal sides, at least in portions.

Expediently, a recess can be formed on the longitudinal wall portions.

This facilitates operating elements (for example a button for releasing a locking of the battery pack) or a labeling surface (information such as technical data of the battery pack).

Within the scope of a preferred embodiment, a (longitudinal) receptacle for holding a tool, an accessory or a consumable can be formed on one longitudinal side or on both longitudinal sides of the holding device, in particular on the base portion. This creates a receptacle on the longitudinal side that is open toward the longitudinal side. Thus, it can be seen directly for a user whether a component is arranged in this receptacle. In addition, this receptacle is also accessible for a user when the holding device, in some cases with a battery pack accommodated therein, is deposited, for example, with the bottom side on the base.

At one end or at both ends of the receptacle, an increasing portion can optionally be formed, in which the depth of the receptacle or the retaining groove decreases toward the end thereof. This facilitates removal of the tool, accessory or consumable, because the component strikes the rising portion by displacement along the longitudinal direction of the receptacle or the retaining groove, wherein the component reaches a position projecting obliquely from the receptacle or the retaining groove.

One or more permanent magnets can advantageously be arranged on the groove base, in the groove base or adjacent to the groove base, in particular in the base portion, and/or on the lateral walls. Thus, the component or components, in some cases additionally, can be held by magnetic force. This optimizes the fixing of the components on the holding device. Different components can be held. A magnet which extends along a longitudinal direction or a plurality of magnets which extend along a longitudinal direction and are spaced apart from one another along the longitudinal direction can be arranged at the designated points.

Expediently, a plurality of receptacles for holding a tool, an accessory or a consumable can be formed on a bottom side of the holding device (facing away from the battery pack or the receiving space for the battery pack), in particular on a bottom of the base portion. As a result, a plurality of, in some cases different, components can be accommodated on the bottom. The receptacles can each be formed as a retaining groove, as described above. The groove cross section of the retaining grooves can each be delimited by a groove base and by two lateral walls (partition wall). The groove cross section can be dimensioned such that the tool is arranged completely within the groove cross section. A free space can preferably remain between the component and the bottom of the holding device. This facilitates storing the holding device. Contamination of the components can be reduced.

Specifically, the receptacles on the bottom (of the holding device or of the base portion) can each extend along a longitudinal direction and can be arranged parallel to one another, wherein adjacent receptacles are separated from one another by a partition wall (lateral wall). As a result, a plurality of separate receptacles for components such as tools are created.

One or more permanent magnets can advantageously be arranged in each partition wall or in every second partition wall (the partition wall after that). A reliable fixing of the components or tools by magnetic force can thereby be achieved. If magnets are provided only in every second partition wall, the number or mass of magnets can be kept low (cost-effective). A long magnet or a plurality of shorter magnets which are spaced apart from one another along a longitudinal direction of the partition wall can be arranged in a partition wall. In the latter variant, magnetic material may in some cases be saved.

Expediently, the receptacles on the bottom can have cross sections of different sizes (groove cross sections) and/or different shapes (groove shapes). In this way, different components or similar components of different sizes can be accommodated on the bottom, for example a saw blade of a jigsaw, a screw bit and/or a drill. This contributes to a flexible application of the holding device.

Within the framework of a preferred embodiment, an aperture for ventilating the battery pack can be formed on one side of the holding device, for example the bottom of the holding device, in particular on the base portion. The aperture can thus form a ventilation channel, so that heat can be conducted away from the battery pack. For example, the holding device can thus remain on the battery pack during the charging of the battery pack. The aperture can be adapted to the cross section of an air duct formed in the battery pack. In cross section, the aperture can be formed to be flat, for example substantially rectangular, trapezoidal or elliptical.

Expediently, the receptacles on the bottom (of the holding device or of the base portion) can extend along the longitudinal direction only over a part of the holding device or of the base portion, wherein the aperture is arranged outside this part (aperture is arranged in a part of the holding device or of the base portion not provided with receptacles).

This optimizes ventilation and thus contributes to good heat dissipation. In addition, this facilitates removal of a tool from a receptacle, because the tool can be pushed along the receptacle to this part and gripped.

In an advantageous manner, the holding device can be formed partially or completely from an elastomer, in particular from a thermoplastic elastomer. A durable design can thereby be achieved. The material is easy to process and also sufficiently elastic. This facilitates an attachment of the holding device to and a removal of the holding device from the battery pack.

Expediently, the holding device can have a coating made of a soft material, in particular a coating made of rubber. This provides protection from impact. The risk of damage to or in the battery pack can be reduced, because accelerations are reduced.

Preferably, the holding device can be formed from a hard component and a soft component (TPE, rubber, elastomer), wherein the soft component at least partially surrounds the hard component (plastic). Thus, the holding device can have a core material (“hard component”) and a coating material (“soft component”).

Within the framework of a preferred embodiment, the surface of the holding device can be non-slip or the holding device can have a cover made of an anti-slip material, for example made of rubber. This improves the fixing of the holding device on the battery pack. The fixing of the tools in the receptacles can also be optimized hereby.

The holding device can advantageously have a light source, in particular with an LED. Thus, the environment can be illuminated at least in portions by means of the holding device. In addition to a light source (LED), the holding device can also have an electrochemical energy store and in some cases a switch.

Expediently, the holding device can have a wire tracer. In this way, electrical lines and/or water lines arranged in a wall can be detected, for example. This can assist the user, for example, before a drilling process.

Within the framework of a preferred embodiment, the holding device can have a charging device for electrical charging of mobile terminals. This enables a power supply of mobile terminals by means of the holding device. The holding device can be electrically connected to the battery pack that is coupled to the holding device, or the holding device can have its own electrochemical energy store. The holding device can have a USB connection as a (wired) interface or be formed as a (wireless) interface for inductive charging.

The holding device can preferably have a coupling device for the coupling of holding means. This further optimizes handling. The coupling device can thus be formed for coupling to a scaffold hook, a belt clip or a Centrotec receptacle.

The aforementioned object is also achieved by a battery pack having the features of the independent claim. Accordingly, the battery pack has a holding device with one or more of the aspects described above.

With regard to the advantages that can be achieved thereby, reference is made to the statements relating to the holding device in this respect.

The measures described in connection with the holding device can serve for further developing the battery pack.

The aforementioned object is also achieved by a machine tool, in particular a hand-held power tool, having the features of the further independent claim. Accordingly, the machine tool has a battery pack and a holding device with one or more of the aspects described above.

With regard to the advantages that can be achieved thereby, reference is made to the statements relating to the holding device in this respect.

The measures described in connection with the holding device can serve for further developing the machine tool.

### BRIEF DESCRIPTION OF THE DRAWINGS

The invention is explained in more detail below with reference to the figures, wherein identical or functionally identical elements are provided with identical reference signs, but where applicable only once. The drawings show:

FIG. 1 a perspective view of an embodiment of a holding device integrated into the battery package;

FIG. 2 the holding device from FIG. 1 in a sectional view according to an axis II-II in FIG. 1;

FIG. 3 a perspective view of an embodiment of a holding device that can be fitted onto the battery package;

FIG. 4 the holding device from FIG. 3 in a bottom view according to arrow IV in FIG. 3;

FIG. 5 the holding device from FIG. 3 in a sectional view according to an axis V—V in FIG. 4; and

FIG. 6 an embodiment of the holding device from FIG. 3 with saw blades accommodated therein in a bottom view.

### DETAILED DESCRIPTION

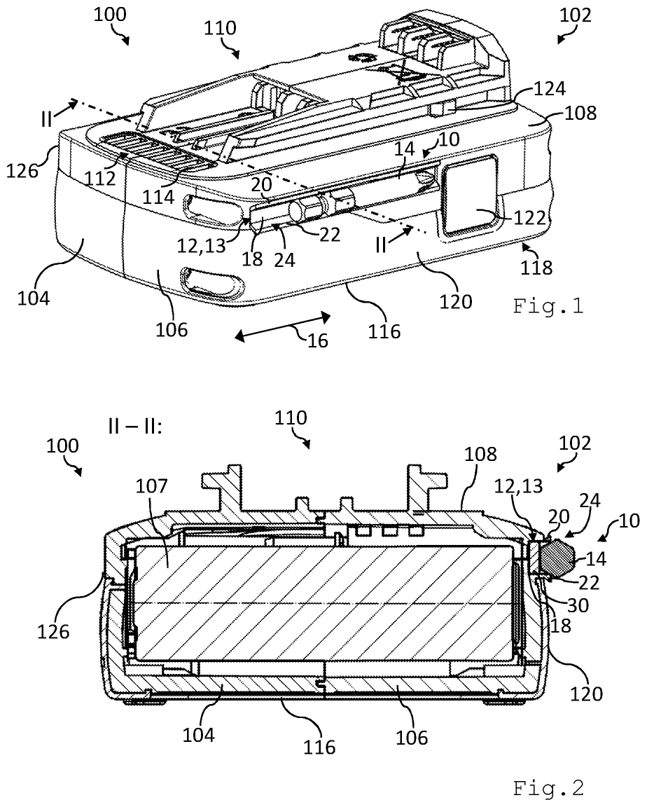

FIG. 1 shows a holding device 10 for arrangement on a battery pack 100 of a machine tool. First, the battery pack 100 is described.

The battery pack 100 in the present case has a housing 102 with a first housing portion 104 and a second housing portion 106. The housing portions 104, 106 are formed here as housing halves, for example. The housing portions 104, 106 are fastened to one another, for example screwed to one another. The components of the battery pack 100, for example the battery cells 107, are arranged in the interior of the housing 102 (cf. FIG. 2).

The battery pack 100 has a coupling device 110 on an upper side 108 (coupling side 108), by means of which the battery pack can be coupled to a machine tool, for example a cordless screwdriver. A ventilation channel 112 for cooling or ventilating the battery pack 100 (cf. FIG. 1) extends through the housing 102 of the battery pack 100. The flow channel 112 has an inlet 114 on the upper side 108 and an outlet 118 on a bottom side 116 (analogous to FIG. 4).

On one longitudinal side 120, the battery pack 100 has a button 122 for actuating a locking element 124, whereby the battery pack 100 can be released from a machine tool (cf. FIG. 1). The battery pack 100 can also have a button for actuating the locking element 124 on the second longitudinal side 126 (not shown).

The holding device 10 will be discussed below. The holding device 10 has a receptacle 12 for holding a component, in the present case a tool 14 for the machine tool (cf. FIGS. 1 and 2).

The receptacle 12 for the tool 14 extends along a longitudinal direction 16. In the example, the tool 14 is an elongated screwing tool in the form of a screw bit.

In the example, the receptacle 12 is formed as a retaining groove 13, the groove cross section (tool holding space) of which is delimited by a groove base 18 and by two lateral walls 20, 22 (which flank the groove base 18 therebetween). The retaining groove 13 is open on its outer side 24 (facing away from the groove base 18).

The groove cross section of the retaining groove 13 is configured and intended for accommodating the tool 14 (in the example, a screw bit). If the tool 14 is arranged in the retaining groove 13, it protrudes in the example partially from the groove cross section (tool 14 only partially accommodated within the groove cross section; cf. FIG. 2). In the example, the retaining groove 13 is arranged on the casing side of the battery pack 100, namely on a longitudinal side 120 of the battery pack.

The lateral walls 20, 22 can have an elastically deformable design, so that they are elastically deformed by the tool 14 when the tool 14 is inserted into the retaining groove 13 and hold the tool 14 in the retaining groove 13. The tool 14 can thus be clamped in the retaining groove 13 by the lateral walls 20, 22.

Optionally, engagement portions, snap hooks or elastomer elements can be arranged on the lateral walls, as described above (not shown).

At least one permanent magnet 30 is arranged on the groove base 18 (cf. FIG. 2). Thus, the tool 14 can be held, possibly additionally, by means of magnetic force. An individual permanent magnet 30, which extends along a longitudinal direction 16, can be arranged on the groove base 18, or a plurality of permanent magnets 30 can be provided which extend along the longitudinal direction 16 and are in some cases spaced apart from one another along the longitudinal direction 16.

In the example, the holding device 10 partially covers the battery pack 100. Thus, the holding device 10 is formed as part of a housing portion of the battery pack 100, in the example as part of the second housing portion 106.

The holding device 10 is fixedly connected to the battery pack 100. In the example, the holding device 10 is fixedly fastened to the housing 102 of the battery pack 100, specifically to the second housing portion 106.

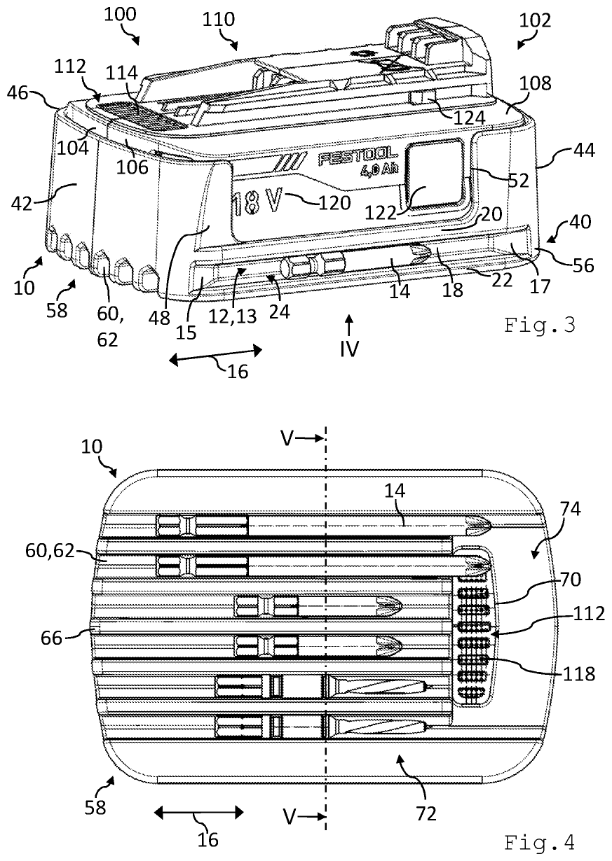

FIGS. 3 to 5 show a holding device 10 which can be placed on a battery pack 100. The battery pack 100 can correspond to battery pack 100 as described above.

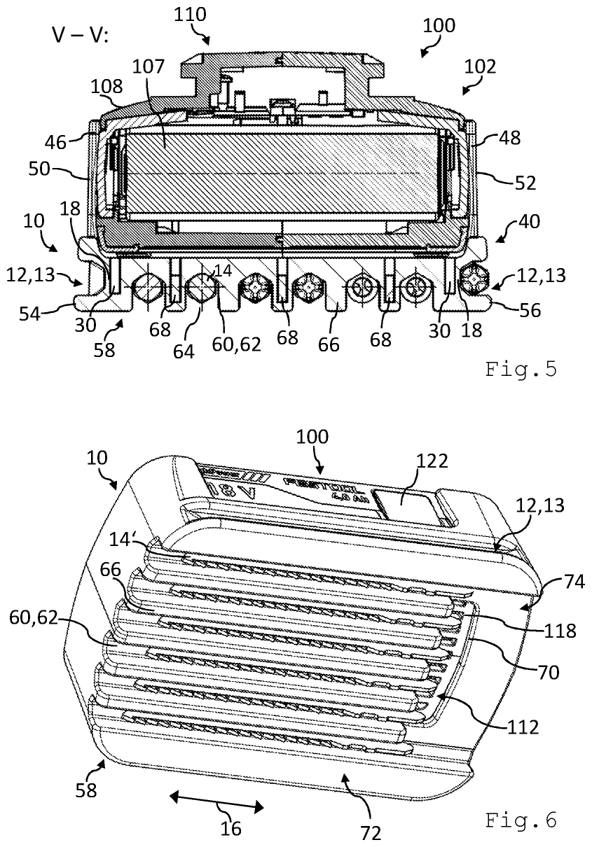

The holding device 10 for arrangement on the battery pack 100 of a machine tool has a plurality of receptacles 12 for holding a component, in the present case a tool 14 for the machine tool (cf. FIG. 5).

The holding device 10 can be placed on the battery pack 100 and is reversibly removable from the battery pack 100, wherein the holding device 10 at least partially surrounds the battery pack 100 in the mounted state (cf. FIG. 3). The holding device 10 is thus formed separately from the battery pack 100 and can be placed on or removed from the battery pack 100 as needed.

The holding device 10 has a base portion 40 and wall portions 42, 44, 46, 48 protruding from the base portion 40, namely face wall portions 42, 44 and longitudinal side wall portions 46, 48, which connect the end wall portions 42, 44 to one another (cf. FIG. 3). The battery pack 100 can thus be protected on the side 116 (bottom 116) facing away from the coupling side 108 and on the casing sides, for example the longitudinal side 120.

A recess 50, 52 is formed on each of the longitudinal wall portions 46, 48 (cf. FIGS. 3 and 5). As a result, space is made for the button 122 and, for example, also a labeling surface.

In the example, a (longitudinal) receptacle 12 for holding a component, in the present case a tool 14 (cf. FIG. 5), is formed on both longitudinal sides 54, 56 of the holding device 10, specifically on the base portion 40.

The receptacle 12 for the tool 14 extends in each case along a longitudinal direction 16. The tool 14 is an elongated screwing tool in the form of a screw bit.

In the example, the receptacle 12 is formed as a retaining groove 13, the groove cross section (tool holding space) of which is delimited by a groove base 18 and by two lateral walls 20, 22 (cf. FIGS. 3 and 5). The retaining groove 13 is open on its outer side 24 (facing away from the groove base 18). At both ends of the receptacle 12 or the retaining groove 13, an increasing portion 15, 17 is formed in each case in which the depth of the receptacle 12 or the retaining groove 13 decreases. This facilitates removal of the tool 14, as explained above.

The groove cross section of the retaining groove 13 is respectively configured and determined for receiving the tool 14 (screw bit). If the tool 14 is arranged in the retaining groove 13, it is arranged flush with the longitudinal side 54, 56 (tool 14 does not protrude or only slightly protrudes from the groove cross section, cf. FIG. 5).

The lateral walls 20, 22 can have an elastically deformable design, so that they are elastically deformed by the tool 14 when the tool 14 is inserted into the retaining groove 13 and hold the tool 14 in the retaining groove 13. The tool 14 can thus be clamped in the retaining groove 13 by the lateral walls 20, 22.

Optionally, engagement portions, snap hooks or elastomer elements can be arranged on the lateral walls 20, 22, as described above (not shown).

At least one permanent magnet 30 is arranged adjacent to the groove base 18, i.e., in the interior of the base portion 40 (cf. FIG. 5). Thus, the tool 14 can be held, possibly additionally, by means of magnetic force. A single permanent magnet 30 can be provided, which extends along a longitudinal direction 16, or a plurality of permanent magnets 30 can be provided, which extend along the longitudinal direction 16 and are in some cases spaced apart from one another along the longitudinal direction 16.

In the example, a plurality of receptacles 60 for holding a tool 14 are formed on a bottom side 58 of the holding device 10 or of the base portion 40 (cf. FIGS. 3 to 5). The receptacles 60 are each formed as a retaining groove 62. In the example, the groove cross section is dimensioned such that the tool 14 is arranged completely within the groove cross section, wherein a free space 64 remains between the tool 14 and the bottom 58 (cf. FIG. 5). In the example, the receptacles 60 or retaining grooves 62 are configured and intended to receive a tool 14 in the form of a screw bit in each case.

The receptacles 60 on the bottom 58 each extend along the longitudinal direction 16 and are arranged parallel to one another (cf. FIGS. 4 and 5). Adjacent receptacles 60 are each separated from one another by a partition wall 66.

In the example, one or more permanent magnets 68 are arranged in each second partition wall 66 (cf. FIG. 5). A (long) permanent magnet or a plurality of (shorter) permanent magnets which are spaced apart from one another along a longitudinal direction of the partition wall 66 can be arranged in a partition wall 66.

An aperture 70 for ventilating the battery pack 100 is formed on one side, in the example on the bottom 58 of the holding device 10 or in the base portion 40 (cf. FIG. 4). The aperture 70 is adapted to the cross section of a ventilation channel 112 formed in the battery pack 100.

The receptacles 60 on the bottom 58 extend along the longitudinal direction 16 only over a part 72 of the holding device 10 or of the base portion 40, wherein the aperture 70 is arranged outside this part 72. The aperture 70 is thus arranged in a part 74 of the holding device 10 or of the base portion 40 that is not provided with receptacles 60.

As described above, the holding device 10 can be formed from an elastomer, in particular from a thermoplastic elastomer. The holding device 10 can have a slip-resistant surface or a cover made of an anti-slip material, for example made of rubber. The holding device 10 can have a coating made of a soft material, in particular a coating made of rubber.

As described above, the holding device 10 can have a light source and/or a wire tracer (not shown). As described above, the holding device 10 can have a charging device for the electrical charging of mobile terminals and/or a coupling device for coupling holding means.

FIG. 6 shows an embodiment of the holding device 10, which largely corresponds to the embodiment described in FIGS. 3 to 5.

In contrast thereto, tools 14′ in the form of jigsaw blades are accommodated in the receptacles 60 on the bottom 58 of the holding device 10 or the base portion 40. The jigsaw blades can be held by magnetic force by means of the permanent magnets 68 arranged in the partition walls 66 (analogously to FIG. 5).

The receptacles 60 can each be formed as retaining grooves 62 and can be formed to receive a screwing tool. As a result, not only jigsaw blades but, for example, also screwing or drilling tools can be held as tools in the receptacles 60.

Optionally, the receptacles 60 can be adapted in cross section to the jigsaw blades. Thus, the receptacles 60 can each have the cross section of a jigsaw blade (not shown) along a part of the height of the receptacle 60 or over the entire height of the receptacle 60.

What is claimed is:

1. A holding device for arrangement on a battery pack of a machine tool, in particular a hand held power tool, comprising at least one receptacle for holding a tool, an accessory or a consumable for the machine tool.

2. The holding device according to claim 1, characterized in that the receptacle is formed as a retaining groove or as a receiving channel wherein the groove cross section of the retaining groove is delimited by a groove base and by at least one lateral wall, wherein the at least one lateral wall is formed to be elastically deformable so that it is elastically deformed when the tool, accessory or consumable is introduced into the retaining groove and holds the tool, accessory part or consumable in the retaining groove.

3. (canceled)

4. (canceled)

5. The holding device according to claim 1, characterized in that the holding device at least partially covers the battery pack and/or is integrated into the battery pack.

6. The holding device according to claim 1, claims, characterized in that the holding device is fixedly connected to the battery pack.

7. The holding device according to claim 1, characterized in that the holding device can be placed on the battery pack and can be reversibly removed from the battery pack, the holding device at least partially surrounding the battery pack in the mounted state.

8. (canceled)

9. The holding device according to claim 1, characterized in that the wall portions comprise end wall portions and longitudinal side wall portions which connect the end wall portions to one another, wherein a recess is formed on each of the longitudinal wall portions.

10. (canceled)

11. The holding device according to claim 1, characterized in that a receptacle for holding a tool, an accessory or a consumable is formed on a longitudinal side or on both longitudinal sides of the holding device on the base portion, wherein an increasing portion in which the depth of the receptacle decreases is formed at one end or at both ends of the receptacle.

12. (canceled)

13. The holding device according to claim 2, characterized in that one or more permanent magnets are arranged on the groove base-, in the groove base or adjacent to the groove base, in particular in the base portion, and/or on the lateral walls.

14. The holding device according to claim 1, characterized in that a plurality of receptacles for holding a tool, an accessory or a consumable is formed on a bottom side of the holding device on a bottom side of the base portion.

15. The holding device according to claim 14, characterized in that the receptacles extend along a longitudinal direction on the bottom and are arranged parallel to one another, wherein receptacles adjacent to one another are separated from one another by a partition wall.

16. The holding device according to claim 15, characterized in that one or more permanent magnets are arranged in each partition wall or in each second partition wall.

17. The holding device according to claim 14, characterized in that the receptacles on the bottom have cross sections of different sizes and/or different shapes.

18. The holding device according to claim 1, characterized in that an aperture for ventilation of the battery pack is formed on the holding device on the base portion.

19. The holding device according to claim 14, characterized in that the receptacles extend on the bottom along the longitudinal direction only over a part of the holding device or the base portion, wherein the aperture is arranged outside this part.

20. The holding device according to claim 1, characterized in that the holding device is partially or completely formed from a thermoplastic elastomer and in that the holding device has a cover made of rubber.

21. (canceled)

22. The holding device according to claim 1, characterized in that the holding device is formed from a hard component and a soft component, the soft component at least partially surrounding the hard component and in that the surface of the holding device is non-slip or that the holding device has a cover made of an anti-slip material.

23. (canceled)

24. The holding device according to claim 1, characterized in that the holding device has a light source, in that the holding device has a wire tracer, in that the holding device has a charging device for electrical charging of mobile terminals and/or on that the holding device has a coupling device for coupling holding means.

25. (canceled)

26. (canceled)

27. (canceled)

28. A battery pack of a machine tool comprising a holding device for arrangement on the battery pack, comprising at least one receptacle for holding a tool, an accessory or a consumable for the machine tool.

29. A machine tool, comprising a battery pack and a holding device for arrangement on the battery pack, comprising at least one receptacle for holding a tool, an accessory or a consumable for the machine tool.
